(19) United States
(12) Patent Application Publication
(10) Pub. No.: US 2005/0237136 A1
(43) Pub. Date: Oct. 27, 2005

(54) Electronic circuit board having microstrip lines

(75) Inventor: Kenji Nakatsuka, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/114,365

(22) Filed: Apr. 26, 2005

(30) Foreign Application Priority Data
Apr. 27, 2004 (JP) 2004-131381

(51) Int. Cl. H01P 3/08

(52) U.S. Cl. 333/238

(57) ABSTRACT

An electronic circuit board includes a first insulating base layer, a ground conductor provided on a lower surface of the first insulating base layer, an insulating thin film layer laminated and fixed on the first insulating base layer, a pair of microstrip lines, the microstrip lines being provided on an upper surface and a lower surface of the insulating thin film layer, a second insulating base layer laminated and fixed on the insulating thin film layer, a conductor pattern provided on an upper surface of the second insulating base layer, and electronic components mounted on the conductor pattern. Opposite surfaces of the microstrip lines are roughened, such that an electrical potential difference between the roughened surfaces of the microstrip lines is suppressed. Further, surfaces of the microstrip lines opposite to the roughened surfaces are substantially planarized.

### BACKGROUND OF THE INVENTION

1. Field of the Invention

The invention relates to an electronic circuit board having microstrip lines.

2. Description of the Related Art

Conventionally, as an electronic circuit board for a high frequency apparatus such as a VCO (voltage controlled oscillator), as shown in FIG. 3, a multilayered board having a microstrip line therein has been widely known. An electronic circuit board 1 shown in FIG. 3 has a first insulating base layer 2 made of a dielectric material, a ground conductor 3 provided on a lower surface of the first insulating base layer 2, a microstrip line 4 provided on an upper surface of the first insulating base layer 2, a second insulating base layer 5, made of a dielectric material, which is laminated and fixed on the first insulating base layer 2, a conductor pattern 6 provided on an upper surface of the second insulating base layer 5, and various electronic components mounted on the conductor pattern 6. Here, a preliminary roughening process is generally performed on the upper surface of the first insulating base layer 2 to securely adhere the microstrip line 4 to the first insulating base layer 2. In addition, in such an electronic circuit board 1, a via hole 8 passing through the second insulating base layer 5 is formed to electrically connect the conductor pattern 6 to the microstrip line 4.

In the above-described conventional electronic circuit board 1, the upper surface of the microstrip line 4 is substantially planarized. However, since the roughening process is performed on the upper surface of the first insulating base layer 2 to enhance the adhesion of the microstrip line 4, the lower surface of the microstrip line 4 is also roughened to have minute prominences and depressions. Specifically, the upper surface of the microstrip line 4 has a surface roughness of about 0.5 μm, while the lower surface of the microstrip line 4 is coarsely roughened by the roughening process to have a surface roughness of about 5 to 13 μm. As a result, the electromagnetic field is concentrated on the lower surface of the microstrip line 4 opposite to the ground conductor 3, which results in increasing the effective resistance on the lower surface due to the surface roughness. In a case in which the frequency of a high frequency current flowing in the microstrip line 4 is equal to or more than 500 MHz, a quality factor Q is drastically reduced. For example, when the frequency of the high frequency current flowing in the microstrip line 4 is 2 GHz and the surface roughness of the microstrip line 4 is equal to or more than 3 μm, the quality factor Q is reduced by half, as compared to the case in which the entire lower surface is planarized.

### SUMMARY OF THE INVENTION

The invention has been made in consideration of the problems in the related art, and it is an object of the invention to provide an electronic circuit board having an improved quality factor Q of a microstrip line in a high frequency region.

In order to achieve the above-described object, there is provided an electronic circuit board according to an aspect of the invention. The electronic circuit board includes a ground conductor provided on one surface of a first insulating base layer, an insulating thin film layer laminated and fixed on the other surface of the insulating base layer, and a pair of microstrip lines, the microstrip lines being provided on both surfaces of the insulating thin film layer so as to oppose to each other with the insulating thin film layer interposed therebetween. The microstrip lines are electrically connected to each other. Further, bonding surfaces of the microstrip lines and the insulating thin film layer are roughened.

In such an electronic circuit board, since opposite surfaces of the pair of microstrip lines are roughened, the microstrip lines are strongly bonded to the insulating thin film layer. On the other hand, the other surface of each of the microstrip line opposite to the roughened surface is substantially planarized. As a result, an electrical potential difference between the opposite surfaces of the microstrip lines (the bonding surfaces of the microstrip lines to the insulating thin film layer) is prevented. Accordingly, a high frequency current hardly flows in the roughened opposite surfaces. That is, an electromagnetic field is concentrated on the planarized surfaces of the microstrip lines which face the ground conductor. Therefore, an undesirable increase in the effective resistance of each of the microstrip lines caused by surface roughness can be suppressed. As a result, even though the frequency of the high frequency current flowing in the microstrip line is high, a quality factor Q of each of the microstrip lines can be prevented from decreasing and quality factors such as CNR (Carrier to Noise Ratio) and the like can be enhanced.

In accordance with the aspect of the invention, it is preferable that the pair of microstrip lines are electrically connected to each other through a via hole passing through the insulating thin film layer. Further, it is preferable that the insulating thin film layer has a very thin thickness.

Further, in accordance with the aspect of the invention, it is preferable that the electronic circuit board further includes a second insulating base layer which is laminated and fixed on a surface of the insulating thin film layer opposite to the first insulting base layer. In this case, a surface of the second insulating base layer opposite to the insulating thin film layer may be a component mounting surface. As a result, a multilayered board having an improved quality factor Q in each of microstrip lines in a high frequency region is obtained.

### BRIEF DESCRIPTION OF THE DRAWINGS

FIG. 1 is a diagram illustrating an electronic circuit board according to an embodiment of the invention;

FIG. 2 is a diagram illustrating an electronic circuit board according to another embodiment of the invention; and

FIG. 3 is a diagram illustrating an electronic circuit board according to a related art.

### DESCRIPTION OF THE PREFERRED EMBODIMENT

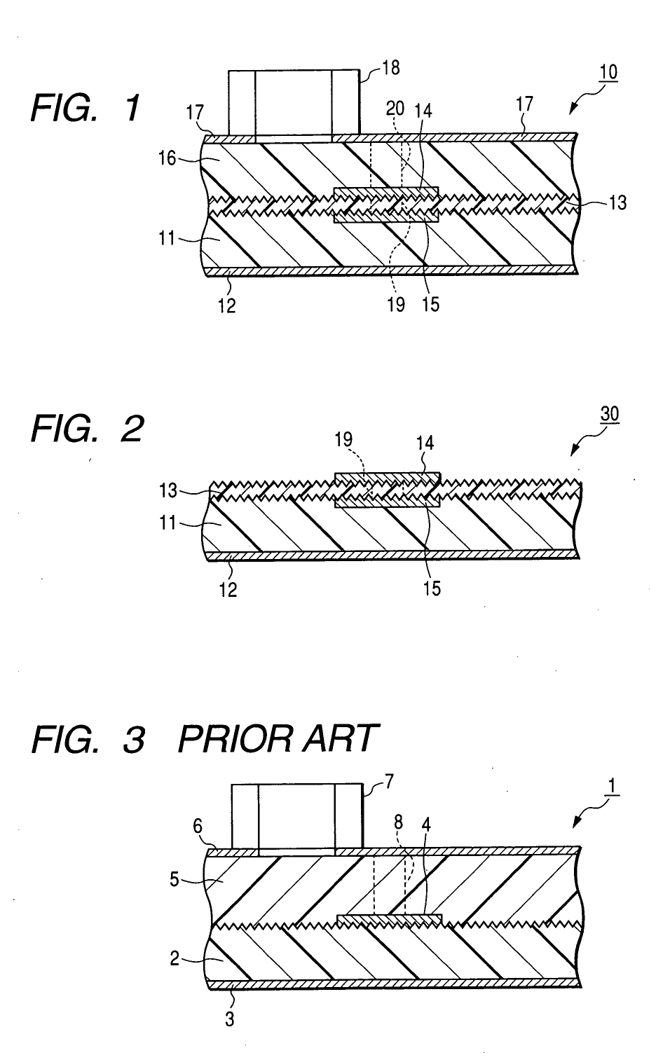

Preferred embodiments of the invention will now be described with reference to the drawings. FIG. 1 is a diagram illustrating an electronic circuit board according to an embodiment of the invention. An electronic circuit board 10 shown in FIG. 1 is a multilayered board for an oscillator such as a VCO (voltage controlled oscillator) or the like. The electronic circuit board 10 includes a first insulating base layer 11 made of a dielectric material such as FR-4, a ground conductor 12, made of copper foil or the like, which is provided on a lower surface of the first insulating base layer 11, an insulating thin film layer 13, made of glass epoxy resin, which is laminated and fixed on the first insulating base layer 11, a pair of microstrip lines 14 and 15, made of copper foils, which are provided on an upper surface and a lower surface of the insulating thin film layer 13, a second insulating base layer 16, made of a dielectric material such as FR-4, which is laminated fixed on the insulating thin film layer 13, a conductor pattern 17, made of copper foil, which is provided on an upper surface of the second insulating base layer 16, and various electronic components 18 mounted on the conductor pattern 17.

Further, in the electronic circuit board 10, the pair of microstrip lines 14 and 15 are provided to face each other with the insulating thin film layer 13 interposed therebetween. In order to strongly adhere the pair of microstrip lines 14 and 15 to the insulating thin film layer 13, a surface roughening process is previously performed on both surfaces of the insulating thin film layer 13. In addition, an opposite surface (that is, a bonding surface to the insulating thin film layer) of each of the pair of microstrip lines 14 and 15 has minute prominences and depressions through the surface roughening process. Accordingly, the opposite surface has a surface roughness of about 5 to 13 μm. The pair of microstrip lines 14 and 15 are electrically connected to each other through a via hole 19 passing through the insulating thin film layer 13 and are also electrically connected to the conductor pattern 17 through a via hole 20 passing through the second insulating base layer 16. That is, the microstrip lines 14 and 15 face each other with the insulating thin film layer 13 interposed therebetween, and in the electronic circuit board 10, the microstrip lines 14 and 15 serve as line conductors.

Moreover, in the present embodiment, the thickness of each of the first and second insulating base layers 11 and 16 is set to about 500 μm, and the thickness of the insulating thin film layer 13 is set to about 50 μm. In addition, a surface of the microstrip line 14 facing the second insulating base layer 16 and a surface of the microstrip line 15 facing the first insulating base layer 11 are planarized surfaces each having a surface roughness of about 0.5 μm.

In the electronic circuit board 10 configured in such a manner, since the opposite surface of each of the microstrip lines 14 and 15 is roughened, the pair of microstrip lines 14 and 15 can be strongly adhered to the insulating thin film layer 13. In addition, an electrical potential difference does not occur between the opposite surfaces of the microstrip lines 14 and 15. Therefore, a high frequency current is suppressed from flowing in the opposite surfaces. On the other hand, the other surface of each of the microstrip lines 14 and 15 opposite to the roughened surface is planarized. That is, a lower surface (a planarized surface) of the microstrip line 15 faces the ground conductor 12 with the first insulating base layer 11 interposed therebetween, and an upper surface (a planarized surface) of the microstrip line 14 faces the conductor pattern 17 with the second insulating base layer 16 interposed therebetween. Therefore, an electromagnetic field is concentrated on the planarized surfaces of the microstrip lines 14 and 15.

Therefore, in the electronic circuit board 10 according to the present embodiment, an undesirable increase in the effective resistance of each of the microstrip lines 14 and 15 caused by surface roughness is suppressed. In a case in which the frequency of a high frequency current flowing in each of the microstrip lines 14 and 15 is 2 GHz, a quality factor Q increases about 20 percent as compared to the case in which only one microstrip line is provided to serve as a line conductor in the electronic circuit board, as described above. More specifically, the quality factor Q in the present embodiment increases about 25 percent as compared to the case in which both surfaces of the microstrip lines 14 and 15 are roughened. In the present embodiment, the insulating thin film layer 13 having a thickness of about 50 μm is interposed. Accordingly, in a case in which the entire thickness of the multilayered board is uniform, the thicknesses of each of the first and second insulating base layers 11 and 16 must be reduced slightly. As a result, the quality factor Q decreases about 5 percent, which causes the quality factor Q in the present embodiment to increase about 20 percent as compared to the above-described conventional configuration. In addition, quality factors such as CNR (carrier to noise ratio) and the like are improved.

In addition, the invention can also be applied to a single-layered electronic circuit board 30 shown in FIG. 2, in addition to the multilayered board. The single-layered electronic circuit board 30 has the same advantages as the above-described embodiment. That is, in the single-layered electronic circuit board 30 shown in FIG. 2, a ground conductor is provided on a lower surface of an insulating base layer 11. Microstrip lines 14 and 15 are provided on an upper surface and a lower surface of an insulating thin film layer 13, respectively. The insulating thin film layer 13 is laminated and fixed on the insulating base layer 11. The microstrip lines 14 and 15 are electrically connected to each other through a via hole 19. In order to strongly adhere the microstrip lines 14 and 15 to both surfaces of the insulating thin film layer 13, a surface roughening process is previously performed on opposite surfaces of the microstrip lines 14 and 15. On the other hand, surfaces opposite to the roughened surfaces of the microstrip lines 14 and 15 are substantially planarized. In this case, a high frequency current is suppressed from flowing in the opposite surfaces. Therefore, an undesirable increase in the effective resistance of each of the microstrip lines 14 and 15 is suppressed. Additionally, a quality factor Q can be improved.

According to the invention, a high frequency current is suppressed from flowing in the roughened surfaces of the microstrip lines and the surfaces of the microstrip lines opposite the roughened surfaces can be substantially planarized. Thus, an undesirable increase in the effective resistance of each of the microstrip lines can be suppressed. Therefore, an electronic circuit board having an improved quality factor Q of each of microstrip lines can be provided.

1. An electronic circuit board comprising:
a ground conductor provided on one surface of a first insulating base layer;
an insulating thin film layer laminated and fixed on another surface of the first insulating base layer; and
a pair of microstrip lines, the microstrip lines being provided on both surfaces of the insulating thin film layer so as to oppose to each other with the insulating thin film layer interposed therebetween,
wherein the microstrip lines are electrically connected to each other, and bonding surfaces of the microstrip lines and the insulating thin film layer are roughened.

2. The electronic circuit board according to claim 1,
wherein the microstrip lines are electrically connected to each other through a via hole passing through the insulating thin film layer.

3. The electronic circuit board according to claim 1 further comprising:
a second insulating base layer laminated and fixed on a surface of the insulating thin film layer opposite to the first insulting base layer,
wherein a surface of the second insulating base layer opposite to the insulating thin film layer is a component mounting surface.
